(19) United States
(12) Patent Application Publication
(10) Pub. No.: US 2002/0061407 A1
(43) Pub. Date: May 23, 2002

(54) Abrasion resistant coating composition and coated articles

(76) Inventors: James P. Colton, Trafford, PA (US); Randy E. Daughenbaugh, Turtle Creek, PA (US); Robin L. Hunt, Pittsburgh, PA (US); Vidhu J. Nagpal, Murrysville, PA (US)

Correspondence Address: PPG INDUSTRIES, INC., Intellectual Property Department, One PPG Place, Pittsburgh, PA, 15272, US

(21) Appl. No.: 10/013,759

(22) Filed: Dec. 10, 2001

Related U.S. Application Data
(63) Continuation-in-part of application No. 09/608,770, filed on Jun. 30, 2000, now abandoned.
Application No. 09/608,770 is a continuation-in-part of application No. 09/588,423, filed on Jun. 6, 2000.
Application No. 09/588,423 is a continuation-in-part of application No. 09/451,169, filed on Nov. 30, 1999, now abandoned.
(60) Provisional application No. 60/114,095, filed on Dec. 29, 1998.

(51) Int. Cl. B32B 9/04; B32B 5/16

(52) U.S. Cl. 428/447; 428/329

(57) ABSTRACT

Describes a coating composition for the preparation of abrasion resistant coatings comprising:

(A) a reaction mixture of

(1) from 5 to 75 weight percent, based on the total weight of the coating composition, of silane monomer(s):

(a) glycidoxy[(C₁-C₃)alkyl]tri(C₁-C₄) alkoxysilane; and

(b) tetra (C₁-C₆)alkoxysilane, the weight ratio of (i) to (ii) ranging from 0.5:1 to 100:1;

(2) a catalytic amount of aqueous acidic alumina sol, sufficient to provide from 0.25 to less than 5 weight percent based on the total weight of silane monomers, of particulate alumina; and

(3) water in an amount sufficient to form hydrolysates of the silane monomers; and

(B) coating composition adjuvant components; and optionally, an adhesion promoter, photopolymerization initiator and/or organic tintability additive provided that the composition does not contain further catalyst for reaction mixture (A). Also described are articles, e.g., lenses, having a tinted or non-tinted cured coating of the aforedescribed coating composition.

### CROSS REFERENCE TO RELATED APPLICATIONS

This application is a continuation-in-part application of application Ser. No. 09/608,770, filed Jun. 30, 2000, now abandoned, which is a continuation-in-part of application Ser. No. 09/588,423, filed Jun. 6, 2000, now abandoned, which is a continuation-in-part application of application Ser. No. 09/451,169, filed Nov. 30, 1999, which claims priority of provisional Application Ser. No. 60/114,095, filed Dec. 29, 1998, which are all incorporated herein by reference.

### DESCRIPTION OF THE INVENTION

The present invention relates to coating compositions used to form durable, i.e., abrasion and chemically resistant, coatings. Particularly, the present invention relates to sol-gel, i.e., solution-gelation, coatings on substrates such as organic polymeric materials. More particularly, this invention relates to articles such as optical elements, e.g., ophthalmic lenses, transparent sheets, and films, having on at least one surface thereof, a durable adherent optically transparent and optionally tintable coating of the present invention.

Polymeric organic material(s) that are typically used to make optical elements, transparent sheets and films, have surfaces that are susceptible to abrasion and chemical attack. Often, such materials are coated with a protective coating to improve their abrasion resistance.

Protective coatings that incorporate epoxy-containing silane monomers, aluminum compounds and other silane monomers have been described in U.S. Pat. 4,702,773, 4,731,264, and 5,462,806 and Japanese Patent Application 2,725,441. U.S. Pat. No. 4,702,773 discloses a coating composition containing an effective abrasion resisting amount of a colloidal dispersion of a water insoluble dispersant such as aluminum oxide in a water-alcohol solution of selected organotrialkoxysilanes. U.S. Pat. No. 4,731,264 discloses an organoalkoxysilane/alumina sol-gel composition and a method for its production. In the '264 patent, the patentees describe hydrolyzing an aluminum alkoxide in water to form a sol to which is added a hydrolyzable organotrialkoxysilane. U.S. Pat. No. 5,462,806 discloses a plastic lens having on at least one surface a primer layer, a hardcoat layer and optionally, a reflection preventing layer. The primer and hardcoat layers, which are prepared from at least one organosilicone compound, may also contain fine particles of inorganic oxides. JP 2,725,441 describes a hard coating agent consisting of an epoxy group-containing difunctional alkoxysilane, a tetrafunctional silane, colloidal titania or alumina and a curing catalyst.

Tintable protective coatings containing epoxy-functional silane monomers and polyepoxy compounds have been described in U.S. Pat. Nos. 4,211,823; 4,525,421 and 5,221,560. The use of organofunctional silanes such as (meth)acryloxy-functional silanes has also been described in the coatings of U.S. Pat. Nos. 4,525,421 and 5,221,560. U.S. Pat. No. 5,221,560 further describes the use of at least one radiation sensitive initiator in the coating. Each of the coatings in the aforedescribed patents includes colloidal silica which is not present in the coating composition of the present invention.

It has now been unexpectedly discovered that by using a catalytic amount of an acidic alumina sol in a coating composition comprising a reaction mixture consisting essentially of (i) glycidoxy[(C₁-C₃)alkyl]tri(C₁-C₄)alkoxysilane and (ii) tetra(C₁-C6)alkoxysilane, the weight ratio of (i) to (ii) being at least 0.5:1, and other adjuvant components, as described hereinafter, a coating may be prepared without the use of added curing catalyst. The coating of the present invention is also more durable, i.e., abrasion resistant, than an identical coating that incorporates an alkyl trialkoxysilane in place of the tetraalkoxysilane of the present invention. The composition of the present invention may be used to produce a durable, single-layer, sol-gel, optionally tintable, adherent cured coating on solid polymeric organic materials using conventional coating technology.

### DETAILED DESCRIPTION

The coating composition of the present invention comprises:

(A) a reaction mixture consisting essentially of:

(1) from 5 to 75 weight percent, based on the total weight of the coating composition, of silane monomer(s):

(a) glycidoxy[(C₁-C₃)alkyl]tri(C₁-C₄) alkoxysilane; and

(b) tetra (C₁-C₆)alkoxysilane, the weight ratio of (i) to (ii) being at least 0.5:1 to 100:1; and

(2) a catalytic amount of an aqueous acidic alumina sol sufficient to provide from 0.25 to less than 5 weight percent, based on the total weight of silane nanomers, of particulate alumina; and

(3) water in an amount sufficient to form hydrolysates of said silane monomers, and

(B) coating composition adjuvant components. The adjuvant components include:

(1) a solvating amount of organic solvent; and

(2) a leveling amount of nonionic surfactant.

The coating composition of the present invention may also contain an adhesion improving amount of organofunctional silane monomer and from 0 to 6 weight percent of a photopolymerization initiator. A polyepoxy compound may also be present in the coating composition with or without the aforementioned organofunctional silane monomer and photopolymerization initiator. The sum of all the components in the coating composition equals 100 percent.

Other than in the operating examples, or where otherwise indicated, all numbers expressing quantities of ingredients or reaction conditions used herein are to be understood as modified in all instances by the term “about”. In each instance where the term “weight percent” is used herein with respect to a coating composition, it is to be understood that the described weight percent is based on the total weight of the coating composition unless indicated otherwise. Whenever the term “silane monomer(s)” is used in reference to components of the coating composition, it is to be understood that the term includes hydrolysates of such silane monomers since water is present in the coating composition in an amount sufficient to form hydrolysates of the silane monomers.

The silane monomer(s) a(i) and (ii) may be present in the coating composition in amounts of at least 5 weight percent, preferably, at least 10 weight percent, more preferably, at least 20 weight percent, and most preferably, at least 25 weight percent. The coating composition usually contains silane monomer(s) a(i) and (ii) in an amount of not more than 75 weight percent, preferably, not more than 70 weight percent, more preferably, not more than 65 weight percent, and most preferably, not more than 60 weight percent. The amount of silane monomer(s) a(i) and (ii) in the coating composition may range between any combination of these values, inclusive of the recited range.

Glycidoxy[(C₁-C₃)alkyl]tri(C₁-C₄)alkoxysilane monomers that may be used in the coating composition of the present invention include glycidoxymethyltriethoxysilane, alpha-glycidoxyethyltrimethoxysilane, alpha-glycidoxyethyl-triethoxysilane, beta-glycidoxyethyltrimethoxysilane, beta-glycidoxyethyltriethoxysilane, alpha-glycidoxy-propyltrimethoxysilane, alpha-glycidoxypropyltriethoxysilane, beta-glycidoxypropyltrimethoxysilane, beta-glycidoxypropyl-triethoxysilane, gamma-glycidoxypropyltrimethoxysilane, hydrolysates thereof, or mixtures of such silane monomers. Preferably, the glycidoxy silane component is glycidoxy[(C₁-C₃)alkyl]tri(C₁-C₂)alkoxysilane, and most preferably is γ-glycidoxypropyltrimethoxysilane.

Suitable tetra(C₁-C₆)alkoxysilanes that may be used in combination with the glycidoxy[(C₁-C₃)alkyl]tri(C₁-C₄)alkoxysilane in the coating composition of the present invention include materials such as tetramethoxysilane, tetraethoxysilane, tetrapropoxysilane, tetrabutoxysilane, tetrapentyloxysilane, tetrahexyloxysilane and mixtures thereof. Preferably, a tetra(C₁-C₄)alkoxysilane is used and most preferably, tetramethoxysilane is used.

In the combination of glycidoxy[(C₁-C₃)alkyl]tri(C₁-C₄)alkoxysilane and tetra(C₁-C₆)alkoxysilane monomers used in the coating composition of the present invention, the monomers may be present in a weight ratio of glycidoxy [(C₁-C₃)alkyl]tri(C₁-C₄)alkoxysilane to tetra(C₁-C₆)alkoxysilane of from at least 0.5:1 to 100:1, preferably at least 0.75:1 to 50:1 and more preferably from at least 1:1 to 5:1. The weight ratio of the silane monomers in the coating composition may range between any combination of these values, inclusive of the recited range.

The amount of acidic alumina sol in the coating composition of the present invention is a catalytic amount i.e., an amount necessary to catalyze or enhance the curing of the coating composition. The alumina sol is characterized by having an acidic pH, i.e., a pH less than 7.0, preferably less than 6.0 and more preferably, less than 5.0. The sol comprises alumina particles, i.e., spherical and/or non-spherical particles of alumina, which may be alumina and/or particles coated with alumina, e.g., alumina coated silica, that have a positive surface charge and an average particle size, i.e., diameter, of not more than 200 nanometers. As used in the present specification and claims, the term “alumina sol” means a colloidal dispersion of finely divided solid inorganic alumina particles in an aqueous-containing liquid, e.g., water. Such alumina sols may be prepared by hydrolyzing a metal salt precursor, e.g., an aluminum halide such as aluminum chloride, for a time sufficient to form the desired particle size. A process for preparing alumina sols and alumina coated silica sols is disclosed in U.S. Patent 3,864,142, which disclosure is incorporated herein by reference. Alternatively, preformed alumina particles may be used with other components that when combined produce the aforedescribed alumina sol.

When the alumina sol is prepared from a metal salt precursor such as aluminum chloride, the alumina sol may be further characterized by having a titratable chloride level in addition to an acidic pH. By the term “titratable chloride level” is meant a level of chloride determined by potentiometric titration with silver nitrate solution using a glass and silver-silver chloride electrode system. Such a method is described in CHLORIDE (4500-Cl) Potentiometric Method, Standard Methods for the Examination of Water and Wastewater, 18th Edition, 1992, pages 4-51 to 4-52, which disclosure is incorporated herein by reference. Typically, the titratable chloride level is an amount at or above the concentration detectable using the aforementioned method, i.e., greater than or equal to 0.01 weight percent, based on the total weight of the alumina sol. The titratable chloride may be at least 0.1 weight percent chloride, preferably at least 1.0 weight percent, more preferably at least 1.5 percent and most preferably at least 3.0 weight percent, chloride, e.g., 3.6 weight percent. The maximum level of chloride in the alumina sol is an amount that does not cause instability of the components, e.g., formation of a precipitate or gel, or prevent the formation of a cosmetically acceptable cured coating when used in the coating composition. The amount of chloride present in the alumina sol may range between any combination of these values, inclusive of the recited range.

The amount of alumina in the coating composition may be at least 0.25 weight percent, preferably at least 0.5 weight percent, more preferably at least 1.0 weight percent and most preferably at least 2.0 weight percent based on the total weight of the silane monomer(s). Typically, the amount of alumina (aluminum oxide) in the coating composition is not more than 10 weight percent, preferably not more than 9 weight percent, more preferably not more than 8 weight percent, and most preferably not more than 5 weight percent. The amount of alumina in the coating composition may range between any combination of these values, inclusive of the recited range.

Examples of commercially available alumina sols that may be used in the composition of the present invention include NALCO® colloidal sols (available from NALCO Chemical Co.), REMASOL® colloidal sols (available from Remet Corp.) and LUDOX® colloidal sols (available from E. I. du Pont de Nemours Co., Inc.). These products may be characterized by their appearance, average particle size, percent alumina, pH, specific gravity, conductivity, viscosity, percent chloride and surface charge. Specific examples of suitable alumina sols that may be used in the coating composition of the present invention are NALCO® 1056 alumina-coated silica sol and NALCO® 8676 colloidal alumina.

The amount of alumina in the alumina sol may vary considerably, e.g., from 3 to 30 weight percent, depending on how the sol was formed. The average particle size of the alumina in the alumina sol is a size that does not adversely effect commercially acceptable “cosmetic” standards for optical coatings applied to optical elements. Examples of cosmetic defects of coated lenses to be avoided include pits, spots, inclusions, cracks and crazing of the coating. The average particle size of the alumina may be at least 1 nanometer (nm), preferably at least 2 nm, and more preferably at least 3 nm. Typically, the average particle size is not more than 200 nm, preferably not more than 100 nm, more preferably, not more than 50 nm, and most preferably not more than 30 nm, e.g., 20 nm. The average particle size of the alumina in the coating composition may range between any combination of these values, inclusive of the recited range.

Organic solvents present in the coating composition of the present invention may be added or formed in situ by the hydrolysis of the silane monomer(s). Suitable organic solvents are those that will dissolve or disperse the solid components of the coating composition. The minimum amount of solvent present in the coating composition is a solvating amount, i.e., an amount which is sufficient to solubilize or disperse the solid components in the coating composition. For example, the amount of solvent present may range from 20 to 90 weight percent based on the total weight of the coating composition and depends, in part, on the amount of silane monomer present in the coating composition. Suitable solvents include, but are not limited to, the following: benzene, toluene, methyl ethyl ketone, methyl isobutyl ketone, acetone, ethanol, tetrahydrofurfuryl alcohol, propyl alcohol, propylene carbonates N-methylpyrrolidinone, N-vinylpyrrolidinone, N-acetylpyrrolidinone, N-hydroxymethylpyrrolidinone, N-butyl-pyrrolidinone, N-ethylpyrrolidinone, N-(N-octyl)-pyrrolidinone, N-(n-dodecyl)pyrrolidinone, 2-methoxyethyl ether, xylene, cyclohexane, 3-methylcyclohexanone, ethyl acetate, butyl acetate, tetrahydrofuran, methanol, amyl propionate, methyl propionate, diethylene glycol monobutyl ether, dimethyl sulfoxide, dimethyl formamide, ethylene glycol, mono- and dialkyl ethers of ethylene glycol and their derivatives, which are sold as CELLOSOLVE industrial solvents by Union Carbide, propylene glycol methyl ether and propylene glycol methyl ether acetate, which are sold as DOWANOL® PM and PMA solvents, respectively, by Dow Chemical and mixtures of such recited solvents.

A leveling amount of nonionic surfactant(s) is present as a component in the coating composition. A leveling amount is that amount which is sufficient to allow the coating to spread evenly or to level the coating composition on the surface of the material, e.g., polymeric organic material, to which it is applied, and provide uniform contact of the coating composition to the surface of the substrate. Preferably, the nonionic surfactant is a liquid at the conditions of use and is used in amounts from about 0.05 to about 1.0 weight percent based on the amount of the silane monomer(s). Suitable nonionic surfactants are described in the Kirk Othmer Encyclopedia of Chemical Technology, 3rd Edition, Volume 22, pages 360 to 377, the disclosure of which is incorporated herein by reference. Other potential nonionic surfactants include the surfactants described in U.S. Pat. No. 5,580,819, column 7, line 32 to column 8, line 46, which disclosure is incorporated herein by reference.

Examples of nonionic surfactants that may be used in the coating composition of the present invention include ethoxylated alkyl phenols, such as the IGEPAL® DM surfactants or octyl-phenoxypolyethoxyethanol sold as TRITON® X-100, an acetylenic diol such as 2,4,7,9-tetramethyl-5-decyne-4,7-diol sold as SURFYNOL® 104, ethoxylated acetylenic diols, such as the SURFYNOL® 400 surfactant series, fluoro-surfactants, such as the FLUORAD® fluorochemical surfactant series, and capped nonionics such as the benzyl capped octyl phenol ethoxylates sold as TRITON® CF87, the propylene oxide capped alkyl ethoxylates, which are available as the PLURAFAC® RA series of surfactants, octylphenoxyhexadecylethoxy benzyl ether, polyether modified dimethylpolysiloxane copolymer in solvent sold as BYK®-306 additive by Byk Chemie, polyalkylene oxidimethylpolysiloxane copolymer sold as NIAX® Silicone 5340 by Witco Corporation and mixtures of such recited surfactants.

Water is also present in the coating composition in an amount sufficient to form hydrolysates of the silane monomer(s). The amount of water necessary may be supplied by the water present in the alumina sol. If not, additional water may be added to the coating composition of the present invention to provide the required additional amount necessary to hydrolyze the silane monomer(s).

Optional ingredients that may be included in the coating composition of the present invention are organofunctional silane monomer(s), photopolymerization initiator(s) and/or polyepoxy compound(s). These components may be used to provide the coating composition with desirable characteristics. The organofunctional silane monomer(s) may be used to improve the adhesion of the coating composition to polymeric surfaces without the use of a surface pretreatment and/or a primer coating. The photopolymerization initiator may be used to initiate the reaction of unreacted double bonds of the organofunctional silane monomer(s) and further cure such a coating using a radiant energy source. The polyepoxy compound may be used to enhance the tintability of the cured coating.

Additions of the optional components to the sol-gel coating of the present invention usually reduce the durable properties of the cured coating. The goal of using such components is to select materials in amounts that provide the desirable characteristics to the cured coating while minimizing any loss of abrasion and chemical resistance.

The organofunctional silane monomer(s) that may be used in the coating composition of the present invention may be represented by the formula:

R¹(R²)ₐSi(OR³)₃₋ₐ

wherein R¹ is vinyl, allyl or (meth)acryloxy(C₁-C₃)alkyl; R² is C₁-C₄ alkyl; R³ is C₁-C₄ alkyl or C₁-C₃ alkoxy(C₁-C₄)alkyl; and a is 0 or 1.

Useful examples of such organofunctional silane monomer(s) may be selected from the group consisting of allyltrimethoxysilane, allyltriethoxysilane, vinyltriethoxysilane, vinyl tri(β-methoxyethoxy)silane, 3-methacryloxypropyltrimethoxysilane, 3-acryloxypropylmethyldiethoxysilane, 3-acryloxypropyltrimethoxysilane, 2-methacryloxyethyltrimethoxysilane, 2-methacryloxyethyltriethoxysilane, 2-acryloxyethyltriethoxysilane and mixtures of such organofunctional silanes. Preferably, the organofunctional silane monomer is 3-methacryloxypropyltrimethoxysilane.

The amount of organofunctional silane monomer(s) that may be used in the coating composition is an adhesion improving amount. An adhesion improving amount is defined herein to be the amount of organofunctional silane monomer necessary to add to the coating composition so that the cured coating shows improved adhesion as compared to a cured coating that is substantially free of the organofunctional silane monomer in the ASTM D-3359-93 Standard Test Method for Measuring Adhesion by Tape Test—Method B. Such an amount of organofunctional silane monomer(s) may range from 4 to 30 weight percent, preferably from 6 to 20 weight percent and more preferably from 8 to 15 weight percent or the amount may range between any combination of these values, inclusive of the recited ranges.

A photopolymerization initiator may be used in conjunction with the organofunctional silane monomers. From 0 to 6 weight percent of the photopolymerization initiator may be present. Preferably the photopolymerization initiator is present in an amount of from 0.01 to 5 weight percent, and more preferably, from 0.1 to 4 weight percent. Alternatively, the amount of photopolymerization initiator may range between any combinations of these values, inclusive of the recited ranges. Examples of useful photopolymerization initiators include benzoin, benzoin methyl ether, benzoin isobutyl ether, benzophenol, acetophenone, 4,4′-dichlorobenzophenone, diethoxyacetophenone, 2-hydroxy-2-methyl-1-phenylpropan-1-one, 2-hydroxy-1-methyl-1-phenyl-1-propanone, 1-hydroxycyclohexyl phenyl ketone, 2-isopropylthixantone and 2,4,6-trimethylbenzoyldiphenylphosphine oxide.

The light source used for the photopolymerization is preferably selected from those which emit ultraviolet light. The light source is preferably a mercury lamp, a germicidal lamp or a zenon lamp. Visible light, e.g., sunlight, may also be used. The exposure time may differ depending upon, e.g., the wavelength and intensity of the light source and the type and amount of initiator used.

The optional polyepoxy compound that may be used in conjunction with the adhesion promoting organofunctional silane monomer(s) or separately is a compound having two or more epoxy groups. Such compounds preferably include a polyglycidyl ether or a polyglycidyl ester group. The polyglycidyl ether compound may be prepared by the reaction of epichlorohydrin with a polyfunctional phenol such as bisphenol A or a polyfunctional aliphatic or alicyclic alcohol having 15 carbon atoms or less to produce diglycidyl ethers of bifunctional phenols, diglycidyl ethers of bifunctional alcohols, diglycidyl ethers of trifunctional alcohols, triglycidyl ethers of trifunctional alcohols, etc. Examples of such polyfunctional aliphatic and alicyclic alcohols include polyethylene glycol, polypropylene glycol, neopentylglycol, glycerol, diglycerol, erythritol, pentaerythritol, dipentaerythritol, trimethylolethane, trimethylolpropane, sorbitol, mannitol, butanediol, hexanediol, 1,4-dihydroxymethylcyclohexane and 2,2-di(4-hydroxycyclohexyl)propane.

The polyglycidyl ester compound may be prepared by the reaction of epichlorohydrin with polyfunctional aliphatic or alicyclic carboxylic acids having 8 carbons or less to produce diglycidyl esters of dicarboxylic acids. Examples of such carboxylic acids include succinic acid, glutaric acid, adipic acid, tetrahydrophthalic acid, hexahydrophthalic acid and hexahydroterephthalic acid.

The polyepoxy compound used in the coating composition may be a single polyglycidyl ether compound, a mixture of polyglycidyl ether compounds, a single polyglycidyl ester compound, a mixture of polyglycidyl ester compounds or a mixture of polyglycidyl ether and polyglycidyl ester compounds. Preferably, the polyepoxy compound is selected from the group consisting of diglycidyl ethers of polyethylene glycol, polypropylene glycol, neopentylglycol, glycerol, trimethylolpropane, bisphenol A and mixtures of diglycidyl ethers of such compounds. Such materials may be synthesized by the reaction of epichlorohydrin with the polyfunctional alcohols or phenols as described in U.S. Pat. No. 4,211,323, which disclosure is incorporated herein by reference.

The amount of polyepoxy compound that may be present in the coating composition of the present invention is a tintable amount. A tintable amount is defined herein to be the amount of polyepoxy compound necessary to add to the coating composition so that a cured coating demonstrates a reduction of at least 50 percent in transmission after being tinted for one hour as described in the Tintability Test of Part D in Example 12 herein. Preferably, the tintable amount of polyepoxy compound causes a reduction to at least 40 percent transmission after 30 minutes, more preferably a reduction to at least 30 percent transmission after 20 minutes and most preferably, a reduction to at least 20 percent transmission after 20 minutes of tinting in the Tintability Test. The amount of polyepoxy compound may range from 9 to 50 weight percent, preferably from 12 to 40 weight percent, more preferably from 15 to 30 weight percent or the amount of polyepoxy compound may range between any combination of these values, inclusive of the recited ranges.

The coating composition of the present invention may be prepared by adding all of the silane monomers to a suitable vessel containing the alumina sol and mixing or vice versa. Typically, an exothermic reaction results from the hydrolysis of the silane monomers. The resulting reaction mixture is stirred for an additional hour while cooling to ambient temperature. Solvent (if required) and surfactant can then be added and the resulting mixture is stirred until all components are dissolved or homogeneously dispersed, e.g., for at least 30 minutes. The resulting coating composition is filtered, e.g., through a nominal 0.45 micron capsule filter, and stored at 4° C. until use.

The optional organofunctional silane monomer(s) may be added with the other silane monomer(s) or may be added to the completed coating composition after the organofunctional silane monomer(s) have been hydrolyzed in an acidic aqueous solution. The photopolymerization initiator may be added with the silane monomers, or more typically, to the completed coating composition with the hydrolyzed organofunctional silane monomer. The polyepoxy compound is typically added after the hydrolysis of the silane monomers.

Prior to applying the coating composition of the present invention, it is typical to treat the surface of the substrate to be coated for the purposes of cleaning the surface and promoting adhesion if an adhesion promoter is not included in the coating composition. Effective treatment techniques for plastics, such as those prepared from CR-39® diethylene glycol bis(allyl carbonate) monomer or thermoplastic polycarbonate, e.g., a resin derived from bisphenol A and phosgene, include ultrasonic cleaning; washing with an aqueous mixture of organic solvent, e.g., a 50:50 mixture of isopropanol: water or ethanol: water; UV treatment; activated gas treatment, e.g., treatment with low temperature plasma or corona discharge, and chemical treatment such as hydroxylation, i.e., etching of the surface with an aqueous solution of alkali, e.g., sodium hydroxide or potassium hydroxide, that may also contain a fluorosurfactant. See U.S. Pat. No. 3,971,872, column 3, lines 13 to 25; U.S. Pat. No. 4,904,525, column 6, lines 10 to 48; and U.S. Pat. No. 5,104,692, column 13, lines 10 to 59, which describe surface treatments of polymeric organic materials.

The coating composition may be applied to the substrate surface using a coating process such as that described in U.S. Pat. No. 3,971,872, the disclosure of which is incorporated herein by reference. Any suitable conventional coating method may be used. Conventional coating methods include flow coating, dip coating, spin coating, roll coating, curtain coating and spray coating. To achieve optimum results in a dip coating process, a uniform, vibration-free withdrawal of the substrate to be coated is necessary. Vibration of the substrate at the air/liquid interface during withdrawal will prevent application of a uniform coating. It is also recommended that continuous filtration of the coating composition through a nominal 0.45 micron filter with recirculation through a dam be done to minimize incorporating particulate matter into the coating.

Application of the coating composition to the substrate surface may done in an environment that is substantially free of dust or contaminants, e.g., a clean room. Coatings prepared by the process of the present invention may range in thickness from 0.1 to 50 microns (μm), preferably from 2 to 20 μm, and more preferably from 2 to 10 μm, e.g., 5 μm. The thickness of the coating may range between any combination of these values, inclusive of the recited ranges.

Following application of the coating composition to the substrate surface, the coating is cured. For handling purposes, the coated substrate may be dried first and then cured. The coating may be dried at ambient temperatures or temperatures above ambient but below curing temperatures, e.g., up to 80° C. Afterwards, the dried, coated surface is heated to a temperature of between 80° C. and 130° C., e.g., 120° C., for a period of from 30 minutes to 16 hours in order to cure the coating. While a range of temperatures has been provided for drying and curing the coating, it will be recognized by persons skilled in the art that temperatures other than those disclosed herein may be used. Additional methods for curing the coating include irradiating it with infrared, ultraviolet, visible or electron radiation.

When a photopolymerization initiator is present in the coating composition, a coated substrate may be irradiated with a curing amount of ultraviolet light, either after thermally curing the coating or simultaneously during the thermal curing process. During the irradiation step, the coated substrate may be maintained at room temperature, e.g., 22° C., or it may be heated to an elevated temperature which is below the temperature at which damage to the substrate occurs.

Tints or colorants may be incorporated into the tintable cured coating of the present invention by various methods described in the art. Such methods include dissolving or dispersing the colorant within the surface of a substrate, e.g., imbibition of the colorant into the substrate by immersion of the substrate in a hot solution of the colorant or by depositing the colorant on the surface of the substrate and thermally transferring the colorant into the substrate. The term “imbibition” or “imbibe” is intended to mean and include permeation of the colorant into the substrate, solvent assisted transfer absorption of the colorant into the substrate, vapor phase transfer and other such transfer mechanisms.

The tints or colorants that may be imbibed into the cured tintable coating of the present invention include static dyes, photochromic compounds or a mixture thereof. As used herein, the term static dyes are substantially free of color change upon exposure to ultraviolet light, i.e., non-photochromic dyes. The classes of static dyes that may be used, include, but are not limited to azo dyes, anthroquinone dyes, xanthene dyes, azime dyes and mixtures thereof. The static dyes and combination of static dyes are typically present in amounts sufficient to provide a desired color and percent transmission of visible light in a tinted cured coating, e.g., 15 percent transmittance as determined using the Hunter spectrophotometer in the Tintability Test. Tints may be imbibed into the tintable coating to reduce the percent transmission by from 1 or 2 percent up to 90 percent, including any number falling within this range.

Photochromic compounds exhibit a reversible change in color when exposed to radiation including ultraviolet rays, such as the ultraviolet radiation in sunlight or the light of a mercury lamp. The photochromic compounds used as colorants in the tintable coating of the present invention may be used alone or in combination with one of more other appropriate complementary organic photochromic compounds, i.e., organic photochromic compounds having at least one activated absorption maxima within the range of 400 and 700 nanometers, and which color when activated to an appropriate hue.

The organic photochromic compounds may include naphthopyrans, e.g., naphtho[1,2-b]pyrans and naphtho[2,1-b]pyrans, quinopyrans, indenonaphthopyrans, oxazines, e.g., benzoxazines, naphthoxazines and spiro(indoline)pyridobenzoxazines, phenanthropyrans, e.g., substituted 2H-phenanthro[4,3-b]pyran and 3H-phenanthro[1,2-b]pyran compounds, benzopyrans, e.g., benzopyran compounds having substituents at the 2-position of the pyran ring, metal-dithiozonates; fulgides, fulgimides and mixtures of such photochromic compounds.

The cured tintable coatings of the present invention may be imbibed with one photochromic compound, a mixture of photochromic compounds, or a mixture of photochromic compounds and static dyes, as desired. The amount of the photochromic compounds to be incorporated into the tintable coating, is not critical provided that a sufficient amount is used to produce a photochromic effect discernible to the naked eye upon activation. Generally, such amount can be described as a photochromic amount. The particular amount used depends often upon the intensity of color desired upon irradiation thereof and upon the method used to incorporate the photochromic colorant. Typically, the more photochromic compound incorporated, the greater is the color intensity up to a certain limit. Methods for incorporating photochromic compounds into polymeric substrates have been disclosed in U.S. Pat. Nos. 4,286,957; 4,880,667; 5,789,015; and 5,975,696, which disclosure is incorporated herein by reference.

The relative amounts of the aforesaid photochromic compounds used will vary and depend in part upon the relative intensities of the color of the activated species of such compounds, the ultimate color desired and the method of application of the photochromic colorant to the tintable coating. In a typical commercial imbibition process, the amount of total photochromic compound incorporated into a receptive coating may range from about 0.05 to about 2.0, e.g., from 0.2 to about 1.0, milligrams per square centimeter of surface to which the photochromic colorant is incorporated or applied.

The substrate, e.g., polymeric organic material, may be in the form of optical elements such as windows, plano and vision correcting ophthalmic lenses, exterior viewing surfaces of liquid crystal displays, cathode ray tubes e.g., video display tubes for televisions and computers, clear polymeric films, automotive transparencies, e.g., windshields, aircraft transparencies, plastic sheeting, etc. Application of the coatings of the present invention to a polymeric film in the form of an “applique” may be accomplished using the methods described in column 17, line 28 to column 18, line 57 of U.S. Pat. No. 5,198,267.

Examples of polymeric organic materials which may be used as substrates for the coating composition of the present invention include: polymers, i.e., homopolymers and copolymers, of the bis(allyl carbonate) monomers, diethylene glycol dimethacrylate monomers, diisopropenyl benzene monomers, ethoxylated bisphenol A dimethacrylate monomers, ethylene glycol bismethacrylate monomers, poly(ethylene glycol) bismethacrylate monomers, ethoxylated phenol bismethacrylate monomers, alkoxylated polyhydric alcohol acrylate monomers, such as ethoxylated trimethylol propane triacrylate monomers, urethane acrylate monomers, such as those described in U.S. Pat. No. 5,373,033, and vinylbenzene monomers, such as those described in U.S. Pat. No. 5,475,074 and styrene; polymers, i.e., homopolymers and copolymers, of mono-functional (meth)acrylate monomers, polyfunctional, e.g., di- or multi-functional, acrylate and/or methacrylate monomers, poly(C₁-C₁₂ alkyl methacrylates), such as poly(methyl methacrylate), poly(oxyalkylene)dimethacrylate, poly(alkoxylated phenol methacrylates), cellulose acetate, cellulose triacetate, cellulose acetate propionate, cellulose acetate butyrate, poly(vinyl acetate), poly(vinyl alcohol), poly(vinyl chloride), poly(vinylidene chloride), polyurethanes, polythiourethanes, thermoplastic polycarbonates, polyesters, poly(ethylene terephthalate), polystyrene, poly(alpha methylstyrene), copoly(styrene-methyl methacrylate), copoly(styrene-acrylonitrile), polyvinylbutyral and polymers, i.e., homopolymers and copolymers, of diallylidene pentaerythritol, particularly copolymers with polyol (allyl carbonate) monomers, e.g., diethylene glycol bis(allyl carbonate), acrylate monomers, e.g., ethyl acrylate, butyl acrylate and mixtures thereof. Further examples of polymeric organic materials are disclosed in the U.S. Pat. No. 5,753,146, column 8, line 62 to column 10, line 34, which disclosure is incorporated herein by reference.

Transparent copolymers and blends of transparent polymers are also suitable as substrates. Preferably, the substrate for the coating composition is an optically clear polymerized organic material prepared from a thermoplastic polycarbonate resin, such as the carbonate-linked resin derived from bisphenol A and phosgene, which is sold under the trademark, LEXAN; a polyester, such as the material sold under the trademark, MYLAR; a poly(methyl methacrylate), such as the material sold under the trademark, PLEXIGLAS; polymerizates of a polyol(allyl carbonate) monomer, especially diethylene glycol bis(allyl carbonate), which monomer is sold under the trademark CR-39®, and polymerizates of copolymers of a polyol (allyl carbonate), e.g., diethylene glycol bis(allyl carbonate), with other copolymerizable monomeric materials, such as copolymers with vinyl acetate, e.g., copolymers of from 80-90 percent diethylene glycol bis(allyl carbonate) and 10-20 percent vinyl acetate, particularly 80-85 percent of the bis(allyl carbonate) and 15-20 percent vinyl acetate, and copolymers with a polyurethane having terminal diacrylate functionality, as described in U.S. Pat. Nos. 4,360,653 and 4,994,208; and copolymers with aliphatic urethanes, the terminal portion of which contain allyl or acrylyl functional groups, as described in U.S. Pat. No. 5,200,483; poly(vinyl acetate), polyvinylbutyral, polyurethane, polythiourethanes, polymers of members of the group consisting of diethylene glycol dimethacrylate monomers, diisopropenyl benzene monomers, ethoxylated bisphenol A dimethacrylate monomers, ethylene glycol bismethacrylate monomers, poly(ethylene glycol) bismethacrylate monomers, ethoxylated phenol bismethacrylate monomers and ethoxylated trimethylol propane triacrylate monomers; cellulose acetate, cellulose propionate, cellulose butyrate, cellulose acetate butyrate, polystyrene and copolymers of styrene with methyl methacrylate, vinyl acetate, acrylonitrile and mixtures thereof.

More particularly contemplated is use of the coating composition of the present invention with optically clear polymerizates, i.e., materials suitable for optical applications, such as for example lenses, i.e., plano and ophthalmic lenses, that are prepared from optical organic resin monomers. Optically clear polymerizates may have a refractive index that may range from 1.48 to 2.00, e.g., from 1.495 to 1.75 or from 1.50 to 1.66. In one contemplated embodiment, a tintable coating applied to a polymeric organic material is imbibed with a colorant selected from static dyes, photochromic compounds or a mixture thereof. The polymeric organic material is in the shape of a lens.

The present invention is more particularly described in the following examples which are intended as illustrative only, since numerous modifications and variations therein will be apparent to those skilled in the art.

### EXAMPLE 1

γ-Glycidoxypropyltrimethoxysilane, 122 grams, and tetramethoxysilane, 28 grams, were added to a suitable vessel and stirred.

NALCO® 8676 colloidal alumina, 91.5 grams, was added to the vessel with stirring. NALCO® 8676 colloidal alumina is a white opalescent liquid, which is reported in NALCO Chemical Company's product literature to be a 10 weight percent suspension of alumina particles in water. The alumina particles are is described as having a positive surface charge, an average particle size of approximately 2 nanometers, a pH of about 4.7 and a titratable chloride level of about 3.6 weight percent. Within ten minutes, the exotherm generated from the hydrolysis of the silanes caused an increase in the temperature of the reaction mixture from about 25° C. to over 50° C. The mixture was stirred for an additional hour while cooling to about 30° C. A 50/50 weight ratio of DOWANOL® PM and PMA solvents, 158.5 grams, was added to the mixture and stirred. BYK®-306 additive, which is reported to be a polyether modified dimethylpolysiloxane copolymer in solvent, 0.4 gram, was added and the resulting mixture was stirred for at least 30 minutes. The resulting coating solution was filtered through a nominal 0.45 micron capsule filter and stored at 4° C. until use.

### EXAMPLE 2

γ-Glycidoxypropyltrimethoxysilane, 240 grams, and tetramethoxysilane, 106.5 grams, were added to a vessel immersed within an ice bath and stirred. NALCO® 8676 colloidal alumina, 205 grams, was added to the vessel with stirring. Within ten minutes, the exotherm generated from the hydrolysis of the silanes caused an increase in the temperature of the reaction mixture from about 5° C. to over 25° C. The mixture was stirred for an additional 3 hours while maintaining the temperature of the reaction mixture near 25° C. A 50/50 weight ratio of DOWANOL® PM and PMA solvents, 350 grams, was added to the mixture and stirred. BYK®-306 additive, 0.9 gram, was added and the resulting mixture was stirred for at least 30 minutes. The resulting coating solution was filtered through a nominal 0.45 micron capsule filter and stored at 4° C. until use.

### EXAMPLE 3

The procedure of Example 2 was followed except that the following were used: 208 grams of γ-glycidoxypropyltri-methoxysilane, 149 grams of tetramethoxysilane, 205 grams of NALCO® 8676 colloidal alumina, 339 grams of a 50/50 weight ratio of DOWANOL® PM and PMA solvents and 0.9 grams of BYK®-306 additive.

### EXAMPLE 4

The procedure of Example 2 was followed except that the following were used: 160 grams of γ-glycidoxypropyl-trimethoxysilane, 213 grams of tetramethoxysilane and 323 grams of a 50/50 weight ratio of DOWANOL® PM and PMA solvents.

### EXAMPLE 5

The procedure of Example 1 was followed except that the following were used: 133 grams of a 50/50 weight ratio of DOWANOL® PM and PMA solvents and 117 grams of NALCO® 1056 alumina-coated silica sol. NALCO® 1056 alumina-coated silica sol was used in place of the NALCO® 8676 colloidal alumina. NALCO® 1056 alumina-coated silica sol is a blue opalescent liquid, which is reported in NALCO Chemical Company's product literature to be a 30 weight percent dispersion containing about 4 percent alumina and about 26 percent silicon dioxide in water. The alumina-coated silica particles are reported as having 5 a positive surface charge, an average particle size of approximately 20 nm, a pH of about 3.7 and a titratable chloride level of about 1.15 weight percent.

### EXAMPLE 6

γ-Glycidoxypropyltrimethoxysilane, 128.5 grams, and tetramethoxysilane, 171.0 grams, were added to a suitable vessel and stirred. NALCO® 8676 colloidal alumina, 52.8 grams, and 61.2 grams of deionized water, were added to the vessel with stirring. Within ten minutes, the exotherm generated from the hydrolysis of the silanes caused an increase in the temperature of the reaction mixture from about 25° C. to over 50° C. The mixture was stirred for an additional hour while cooling to about 30° C. Glycerol diglycidylether, 211.0 grams, and a 50/50 weight ratio of DOWANOL® PM and PMA solvents, 325.0 grams, were added to the mixture and stirred. NIAX® Silicone 5340, which is reported to be a polyalkyleneoxidimethylpolysiloxane copolymer, 1.0 gram, was added and the resulting mixture was stirred for at least 30 minutes. The resulting coating solution was filtered through a nominal 0.45 micron capsule filter and stored at 4° C. until use.

### EXAMPLE 7

The procedure of Example 6 was followed except that the following amounts of materials were used: 520 grams of γ-glycidoxypropyltrimethoxysilane, 372 grams of tetramethoxysilane, 164 grams of NALCO®8676 colloidal alumina, 144 grams of deionized water, 656 grams of glycerol diglycidylether, 1,934 grams of a 50/50 weight ratio of DOWANOL® PM and PMA solvents and 4.0 grams of NIAX® Silicone 5340.

### EXAMPLE 8

### Part A

Methacryloxypropyltrimethoxysilane, 10.0 grams, was added to a beaker containing 2.1 grams of deionized water. One drop of nitric acid was added and the reaction mixture was stirred for 30 minutes.

### Part B

The product of Part A, 6.0 grams, was added to 10 grams of the product of Example 1 resulting in a coating composition having 30.7 weight percent methacryloxypropyltrimethoxysilane, based on the total weight of the composition. Darocure 1173, which is reported to be 2-hydroxy-1-methyl-1-phenyl-1-propanone (from Ciba-Geigy) was added in an amount sufficient to result in the coating composition having 3.0 weight percent, based on the total weight of the composition.

### EXAMPLE 9

The procedure of Example 8 was followed except that 3.0 grams of the product of Part A was added to 10 grams of the product of Example 1 resulting in a coating composition having 18.9 weight percent methacryloxypropyltrimethoxysilane, based on the total weight of the composition.

### EXAMPLE 10

The procedure of Example 8 was followed except that 1.4 grams of the product of Part A of Example 8 was added to 10 grams of the product of Example 2, resulting in a coating composition having 11.8 weight percent methacryloxypropyltrimethoxysilane, based on the total weight of the composition.

### EXAMPLE 11

The procedure of Example 8 was followed except that 3.0 grams of the product of Part A of Example 8 was added to 10 grams of the product of Example 2 to produce an intermediate product. 10 grams of this intermediate product was added to 20 grams of the product of Example 2 resulting in a coating composition having 7 weight percent methacryloxypropyltrimethoxysilane, based on the total weight of the composition.

### COMPARATIVE EXAMPLE 1

The procedure of Example 1 was followed except that the tetramethoxysilane was replaced with 26 grams of methyltrimethoxysilane and the following amounts of the other materials were used: 122 grams of γ-glycidoxypropyltrimethoxysilane; 91.5 grams of NALCO® 8676 colloidal alumina; and 158.5 grams of a 50/50 weight ratio of DOWANOL® PM and PMA solvents.

### COMPARATIVE EXAMPLE 2

The procedure of Example 8 was followed except that 0.25 gram of the product of Part A was added to 5.0 grams of the product of Example 1 resulting in a coating composition having 3.9 weight percent methacryloxypropyltrimethoxysilane, based on the total weight of the composition.

### COMPARATIVE EXAMPLE 3

The procedure of Example 1 was followed except that tetramethoxysilane was not included and the following amounts of the other materials were used: 144 grams of γ-glycidoxypropyltrimethoxysilane; 74 grams of NALCO® 8676 colloidal alumina; and 182 grams of a 50/50 weight ratio of DOWANOL® PM and PMA solvents.

### COMPARATIVE EXAMPLE 4

The procedure of Comparative Example 3 was followed except that the following were used: 162 grams of a 50/50 weight ratio DOWANOL® PM and PMA solvents and 94 grams of NALCO® 1056 alumina-coated silica sol. NALCO® 1056 alumina-coated silica sol was used in place of the NALCO® 8676 colloidal alumina.

### COMPARATIVE EXAMPLE 5

The procedure of Comparative Example 3 was followed except that the following were used: 193 grams of a 50/50 weight ratio of DOWANOL® PM and PMA solvents and 100 grams of NALCO® 1034A colloidal silica. NALCO® 1034A colloidal silica was used in place of NALCO® 8676 colloidal alumina. NALCO® 1034A colloidal silica is a white liquid, which is reported in NALCO Chemical Company's product literature to be a 34 weight percent suspension of is colloidal silica in water (the silica particles having a slightly negative surface charge and an average particle size of approximately 20 nm), has a pH of about 3.0 and a titratable chloride level of less than 0.01 weight percent.

### COMPARATIVE EXAMPLE 6

The procedure of Comparative Example 3 was followed except that 150 grams of epoxycyclohexylethyltrimethoxysilane was used in place of the γ-glycidoxypropyltrimethoxysilane, and 100 grams of NALCO®D 8676 colloidal alumina and 200 grams of a 50/50 weight ratio of DOWANOL® PM and PMA solvents were used.

### EXAMPLE 12

### Part A

Uncoated lenses made of optical grade thermoplastic polycarbonate from Sola Optical USA were washed with soapy water, rinsed with deionized water, rinsed with isopropyl alcohol and dried under a stream of nitrogen gas. The lenses were 65 mm in diameter.

Uncoated lenses made of CR-39® monomer, available from PPG Industries, Inc., were cleaned with acetone; washed with soapy water; rinsed with deionized water; soaked in a 12.5 weight percent sodium hydroxide solution in an ultrasonic bath maintained at 50° C. for 3 minutes; sequentially rinsed in two ultrasonic baths containing deionized water maintained at 50° C.; rinsed with isopropyl alcohol; and dried in a convection oven maintained at 60° C.

### Part B

The coating solutions of Examples 1-5 and Comparatives Example 1, 3, 4, 5 and 6 were warmed to room temperature (about 20-24° C.) with stirring, if necessary. Approximately 3 milliliters (mL) of each coating solution was applied to the surface of the CR-39® monomer lenses prepared in Part A via spin coating at about 1100 rpm. The spinning was stopped after 10 seconds to produce a coating thickness of between 2-3 microns on each lens. The coated lenses were initially held at 60° C. for 20 minutes and then cured at 120° C. for 3 hours. The same procedure was done with the solutions of Example 8 and Comparative Example 2 except that the solutions were applied to the thermoplastic polycarbonate lenses prepared in Part A. The procedure used for the solutions of Example 8 and CE 2 was done with the solutions of Examples 9, 10 and 11 except that they were applied at a spin coating speed of about 400 rpm and the coating thicknesses were not determined.

The coating solutions of Examples 1, 6, 7 and 9 were applied to the lenses made of CR-39® monomer prepared in Part A by dipcoating. The withdrawal rate used was approximately 10 to 15 centimeters per minute to achieve a cured coating thickness of 2-3 microns. Afterwards, the lenses coated with Examples 1, 6 and 7 were dried and cured in an air circulating oven for 3 hours at 120° C.

The lenses coated with the solution of Example 9 were cured in an oven at 120° C. for 3 hours. Two of the six lenses that received no further treatment were designated Example 9A lenses. The other lenses were further cured by exposure to ultraviolet radiation and were designated Example 9B lenses. The lenses were subjected to two passes on a conveyor belt at a speed of 3 feet per minute, 4 inches beneath a 6 inch long ultraviolet “Type D” lamp from Fusion U.V.

Systems, Inc., rated at an output of 300 Watts per inch.

### Part C

Abrasion resistance of the lenses of CR-39® monomer coated with the solutions of Examples 1-5 and Comparative Examples 1, 3, 4, 5 and 6 prepared in Part B was determined using ASTM F735-81 Standard Test Method for Abrasion Resistance of Transparent Plastics and Coatings Using the Oscillating Sand Method. The test samples were exposed to 300 cycles of oscillation in the ASTM Test Method using either sand or alundum as indicated. The Bayer Abrasion Resistance Index (BARI), listed in Table 1 for duplicate samples, was calculated by dividing the percent haze of an uncoated test sample made of a homopolymer prepared from CR-39® monomer by the percent haze of the coated test sample. The resulting number is an indication of how much more abrasion resistant the coated test sample is as compared to the uncoated test square. The haze and transmission results before and after abrasion testing were measured with a Hunter Lab Model DP25P Colorimeter.

Adhesion of the coatings of Examples 8, 9, 10, 11 and CE 2 on the thermoplastic polycarbonate lenses was measured using ASTM D-3359-93 Standard Test Method for Measuring Adhesion by Tape Test-Method B. Testing was performed prior to immersing the lenses in boiling deionized water and after 60 minutes of immersion in the boiling water. Immersion in boiling water simulated chemical attack. The adhesion test results revealed no loss of the coating before or after immersion in the boiling water for all of the Examples tested except for Comparative Example 2. The coating of Comparative Example 2 failed the initial tape test.

### Part D

Coated lenses, as well as uncoated control lenses, made of CR-39® monomer were tested using the Tintability Test to quantitatively determine their tintability. The Tintability Test was used to measure the uptake of dye by both sides of a lens. All of the lenses were prepared as described in Part A. The solutions of Examples 1, 6, 7 and 9 were applied as described in Part B.

The dye solution for the Tintability Test was prepared by adding 1 part BPI Molecular Catalytic Dye available from Brain Power Incorporated and 10 parts deionized water to a beaker that was maintained at a temperature of 95±5° C. The resulting dye solution was stirred for 1 hour prior to testing.

Control and coated lenses for the Tintability Test were washed in soapy water, rinsed with water, dried, placed in clamping devices and immersed in the dye bath.

Lenses were removed from the dye bath in the Tintability Test after intervals of about 5 minutes up to 30 minutes, except for the lens coated with Example 1, which was tested after about 60 minutes. The lenses were immersed in and rinsed with deionized water, air dried at room temperature or manually wiped with absorbent tissue and tested in a Hunter spectrophotometer for percent transmission. The results reported in Table 2 for certain samples are an average of readings made on at least two lenses. Multiple samples were tested for the Uncoated Control at 5, 10 and 20 minutes and Example 7 at 5, 15 and minutes.

The percent transmission through a 1 inch diameter area of each sample lens was determined after the pre-determined time intervals in the dye bath. The average percent transmission of untinted coated lenses was approximately 93. The tintability of the coated lens corresponded to the percent transmission, e.g., the greater the percent transmission, the less tintable the lens, the lower the percent transmission, the more tintable the lens. The results are listed in Table 2.

TABLE 1

| Example Number | BARI (sand) | BARI (alundum) |
|---|---|---|
| 1 | 9.08 | - - - |
| 2 | - - - | 6.26 |
| 3 | - - - | 6.58 |
| 4 | - - - | 7.40 |
| 5 | 7.26 | - - - |
| CE1 | - - - | 4.76 |
| CE3 | 6.71 | - - - |
| CE4 | 5.50 | - - - |
| CES | 4.75 | - - - |
| CE6 | 2.40 | - - - |

TABLE 2
Percent Transmission

| | | Ex- | Ex- | Ex- | Ex- | Ex- |
|---|---|---|---|---|---|---|
| | | ample | ample | ample | ample | ample |
| Time | Control | 1 | 6 | 7 | 9A | 9B |
| 5 | 29.6 | — | 63.6 | 51.3 | — | 65.0 |
| 10 | 12.2 | — | 43.2 | 34.3 | 19.0 | 63.0 |
| 15 | 6.7 | — | — | 20.9 | — | 46.4 |
| 20 | 4.0 | — | 17.3 | 12.7 | 8.6 | 37.5 |
| 25 | — | — | — | 9.1 | — | — |
| 30 | — | — | 8.4 | 6.6 | — | — |
| 60 | — | 86.7 | — | — | — | — |

The results of Table 1 show that the lenses coated with Comparative Example (CE) 1, which contains a methyltrimethoxysilane in place of a tetramethoxysilane, were less resistant to abrasion than the lenses coated with the compositions of Examples 1-5. Comparison of the results for Comparative Example 5 to Comparative Example 3 reveals that the use of aqueous acidic silica sol with γ-glycidoxypropyltrimethoxysilane in the reaction mixture did not produce a coating having the abrasion resistance of a coating using aqueous acidic alumina sol and γ-glycidoxypropyltrimethoxysilane in the reaction mixture. Comparison of the results for Comparative Examples 3 and 4 to Examples 1 and 5, respectively, reveal that the use of γ-glycidoxypropyltrimethoxysilane and aqueous acidic alumina sol without tetra(C₁-C₆)alkoxysilane in the reaction mixture did not produce a coating having the abrasion resistance of the present invention. Comparison of the results for Comparative Example 6 to Comparative Example 3 reveals that the use of epoxycyclohexylethyltrimethoxysilane and aqueous acidic alumina sol in the reaction mixture did not produce a coating having the abrasion resistance of a coating using γ-glycidoxypropyltrimethoxysilane and aqueous acidic alumina sol in the reaction mixture.

Applicants have unexpectedly discovered that by using a catalytic amount of aqueous acidic alumina sol in the reaction mixture with (i) glycidoxy [(C₁-C₃) alkyl]tri(C₁-C₄)alkoxysilane and (ii) tetra(C₁-C₆)alkoxysilane, the weight ratio of (i) to (ii) being at least 0.5:1, a coating may be prepared without the used of added curing catalyst. Based on the data herein, the coating of the present invention is more abrasion resistant that (1) a coating using aqueous acidic silica sol in place of aqueous acidic alumina sol, (2) a coating using epoxycyclohexylethyltrimethoxysilane in place of γ-glycidoxypropyltrimethoxysilane, and (3) a coating using γ-glycidoxypropyltrimethoxysilane in place of a combination of γ-glycidoxypropyltrimethoxysilane and tetraalkoxysilane.

The results of Table 2 showed that the lenses coated with the solutions of Example 6 and 7, which contained the tintable additive, and Example 9, which contained the adhesion promoter, became more tinted in a shorter period of time than the lens coated with the solution of Example 1 without the tintable additive in the Tintability Test. The percent transmission of 86.7 after 1 hour of tinting for Example 1 was higher than the minimal level of reduction of at least 50 percent to be considered tintable in the Tintability Test described herein. Also, the lenses of Example 9A, which were thermally cured, were more tinted than the lenses of Example 9B, which were additionally cured by exposure to ultraviolet radiation, after equivalent time intervals in the Tintability Test.

Although the present invention has been described with reference to the specific details of particular embodiments thereof, it is not intended that such details be regarded as limitations upon the scope of the invention except as and to the extent that they are included in the accompanying claims.

We claim:

1. A coating composition comprising:
(A) a reaction mixture consisting essentially of:
(1) from 5 to 75 weight percent, based on the total weight of the coating composition, of silane monomers:
(a) glycidoxy((C₁-C₃)alkyl) tri(C₁-C₄) alkoxysilane; and
(b) tetra(C₁-C₆)alkoxysilane, the weight ratio of (a) to (b) ranging from 0.5:1 to 100:1;
(2) a catalytic amount of aqueous acidic alumina sol sufficient to provide from 0.25 to less than 5 weight percent, based on the total weight of silane monomers, of particulate alumina; and
(3) water in an amount sufficient to form hydrolysates of said silane monomers; and
(B) coating composition adjuvant components;
provided that the composition contains no further catalyst for said reaction mixture (A).

2. The coating composition of claim 1 wherein the adjuvant components include:
(a) a solvating amount of organic solvent; and
(b) a leveling amount of nonionic surfactant.

3. The coating composition of claim 1 wherein an adhesion improving amount of organofunctional silane represented by the formula:
R¹(R²)ₐSi(OR³)₃₋ₐ
wherein R¹ is vinyl, allyl, (meth)acryloxy(C₁-C₃)alkyl; R² is C₁-C₄ alkyl; R³ is C₁-C₄ alkyl or C₁-C₃ alkoxy(Cl-C4)alkyl; and a is 0 or 1; and from 0 to 6 weight percent of a photopolymerization initiator are also present.

4. The coating composition of claim 3 wherein the organofunctional silane is present in an amount of from 4 to 30 weight percent and said organofunctional silane is selected from the group consisting of allyltrimethoxysilane, allyltriethoxysilane, vinyltriethoxysilane, vinyl tri(β-methoxyethoxy)silane, 3-methacryloxypropyl-trimethoxysilane, 3-acryloxypropylmethyldiethoxy-silane, 3-acryloxypropyltriemthoxysilane, 2-methacryloxyethyltriemthoxysilane, 3-methacryloxypropyltrimethoxysilane, 2-methacryloxyethyltriethoxysilane, 2-acryloxyethyltriethoxysilane and mixtures of such organofunctional silanes; and the photopolymerization initiator is present in an amount of from 0.01 to 5 weight percent.

5. The coating composition of claim 4 wherein from 8 to 15 weight percent 3-methacryloxypropyltrimethoxysilane and from 0.1 to 4 weight percent photopolymerization initiator are present.

6. The coating composition of claim 1, wherein a tintable amount of polyepoxy compound(s) is also present.

7. The coating composition of claim 6 wherein the polyepoxy compound is present in an amount of from 9 to 50 weight percent and said polyepoxy compound(s) is selected from the group consisting of diglycidyl ethers of bifunctional alcohols, diglycidyl ethers of trifunctional alcohols, diglycidyl ethers of bifunctional phenols, diglycidyl esters of dicarboxylic acids and mixtures of such polyepoxy compounds.

8. The coating composition of claim 7 wherein from 15 to 30 weight percent of polyepoxy compound(s) selected from the group consisting of diglycidyl ethers of polyethylene glycol, polypropylene glycol, neopentylglycol, glycerol, trimethylol propane, bisphenol A and mixtures of diglycidyl ethers of such compounds are present in said coating composition.

9. The coating composition of claim 1 wherein an adhesion improving amount of organofunctional silane(s) represented by the formula:
R¹(R²)ₐSi(OR³)₃₋ₐ
wherein R¹ is vinyl, allyl, (meth)acryloxy(C₁-C₃)alkyl; R² is C₁-C₄ alkyl; R³ is C₁-C₄ alkyl or C₁-C₃ alkoxy(C₁-C₄)alkyl; and a is 0 or 1, from 0 to 6 weight percent photopolymerization initiator and a tintable amount of polyepoxy compound(s) are present.

10. The coating composition of claim 1 wherein the silane monomers (A)(1)(a) and (b) range from 10 to 60 weight percent of the composition and are glycidoxy((C₁-C₃)alkyl) tri(C₁-C₂)alkoxysilane and tetra(C₁-C₄)alkoxysilane in a weight ratio ranging from 0.75:1 to 50:1.

11. The coating composition of claim 10 wherein the silane monomer(s) range from 20 to 50 weight percent of the composition and are γ-glycidoxypropyltrimethoxysilane and tetramethoxysilane in a weight ratio ranging from 1:1 to 5:1.

12. The coating composition of claim 1 wherein the average particle size of the alumina is not more than 200 nanometers.

13. The coating composition of claim 12 wherein the average particle size of the alumina ranges from 2 to 30 nanometers and the amount of alumina in said coating composition ranges from 1 weight percent to less than 5 weight percent.

14. The coating composition of claim 2 wherein the solvating amount of organic solvent is up to 90 weight percent of the coating composition.

15. An article comprising in combination, a polymeric organic material and on at least one surface thereof a coating prepared by curing a coating composition comprising:
(A) a reaction mixture consisting essentially of:
(1) from 5 to 75 weight percent, based on the total weight of the coating composition, of silane monomers:
(a) glycidoxy((Cl-C₃)alkyl) tri(C₁-C₄) alkoxy-silane; and
(b) tetra(C₁-C₆)alkoxysilane, the weight ratio of (a) to (b) ranging from 0.5:1 to 100:1; and
(2) a catalytic amount of aqueous acidic alumina sol sufficient to provide from 0.25 to less than 5 weight percent, based on the total weight of silane monomers, of particulate alumina; and
(3) water in an amount sufficient to form hydrolysates of said silane monomers; and
(B) coating composition adjuvant components;
provided that the composition contains no further catalyst for said reaction mixture (A).

16. The article of claim 15 wherein the adjuvant components of the coating composition include:
(a) a solvating amount of organic solvent; and
(b) a leveling amount of nonionic surfactant.

17. The article of claim 15 wherein the coating composition optionally includes:
(a) an adhesion improving amount of an organofunctional silane represented by the formula:
R¹(R²)ₐSi(OR³)₃₋ₐ
wherein R¹ is vinyl, allyl, (meth)acryloxy(C₁-C₃)alkyl; R² is C₁-C₄ alkyl; R³ is C₁-C₄ alkyl or C₁-C₃ alkoxy(C₁-C₄)alkyl; and a is 0 or 1 and from 0 to 6 weight percent of a photopolymerization initiator;
(b) a tintable amount of polyepoxy compound(s); or
(c) a combination of (a) and (b).

18. The article of claim 15 wherein the silane monomer(s) (A)(1)(a) and (b) in the coating composition range from 20 to 50 weight percent of the composition and are γ-glycidoxypropyltrimethoxysilane and tetramethoxysilane in a weight ratio ranging from 1:1 to 5:1.

19. The article of claim 18 wherein the average particle size of the alumina in the coating composition ranges from 2 to 30 nanometers and the amount of alumina in said coating composition ranges from 1 weight percent to less than 5 weight percent.

20. The article of claim 17 wherein the organofunctional silane (a) is present in the coating composition in an amount of from 4 to 30 weight percent and said organofunctional silane is selected from the group consisting of allyltrimethoxysilane, allyltriethoxysilane, vinyltriethoxysilane, vinyl tri(β-methoxyethoxy)silane, 3-methacryloxypropyltrimethoxysilane, 3-acryloxypropylmethyldiethoxysilane, 3-acryloxypropyltrimethoxysilane, 2-methacryloxyethyltrimethoxysilane, 3-methacryloxypropyltriethoxysilane, 2-methacryloxyethyltriethoxysilane, 2-acryloxyethyltriethoxysilane and mixtures of such organofunctional silanes; and the photopolymerization initiator is present in an amount of from 0.01 to 5 weight percent.

21. The article of claim 17 wherein the polyepoxy compound(s) (b) is present in the coating composition in an amount of from 9 to 50 weight percent and said polyepoxy compound(s) is selected from the group consisting of diglycidyl ether of bifunctional alcohols, diglycidylethers of trifunctional alcohols, diglycidylethers of bifunctional phenols, diglycidyl esters of dicarboxylic acids and mixtures of such polyepoxy compounds.

22. The article of claim 21 wherein the coating composition includes from 4 to 30 weight percent organofunctional silanes, and from 0.1 to 5 weight percent photopolymerization initiator.

23. The article of claim 21 wherein said cured coating further comprises an imbibed colorant selected from static dyes, photochromic compounds or a mixture thereof.

24. The article of claim 15 wherein the polymeric organic material is selected from polyacrylates, polymethacrylates, poly(C₁-C₁₂) alkyl methacrylates, polyoxy(alkylene methacrylates), poly (alkoxylated phenol methacrylates), cellulose acetate, cellulose triacetate, cellulose acetate propionate, cellulose acetate butyrate, poly(vinyl acetate), poly(vinyl alcohol), poly(vinyl chloride), poly(vinylidene chloride), thermoplastic polycarbonates, polyesters, polyurethanes, polythiourethanes, poly(ethylene terephthalate), polystyrene, poly(alpha methylstyrene), copoly(styrene-methylmethacrylate), copoly(styrene-acrylonitrile), polyvinylbutyral and polymers of polyol(allyl carbonate) monomers, polyfunctional acrylate monomers, polyfunctional methacrylate monomers, diethylene glycol dimethacrylate monomers, diisopropenyl benzene monomers, alkoxylated polyhydric alcohol monomers, diallylidene pentaerythritol monomers or mixtures thereof.

25. The article of claim 24 wherein the article is a lens.
